(19) United States
(12) Patent Application Publication
(10) Pub. No.: US 2005/0036250 A1
(43) Pub. Date: Feb. 17, 2005

(54) Power converter apparatus and method for controlling the same

(76) Inventor: Hiroaki Asano, Kariya-shi (JP)

Correspondence Address: Morgan & Finnegan, L.L.P., 3 World Financial Center, New York, NY, 10281-2101, US

(21) Appl. No.: 10/912,950

(22) Filed: Aug. 5, 2004

(30) Foreign Application Priority Data
Aug. 7, 2003 (JP) 2003-289174

(51) Int. Cl. H02H 3/00

(52) U.S. Cl. 361/42

(57) ABSTRACT

A power converter apparatus converts electricity supplied from a power source into a different form and outputs the electricity to an output line. The apparatus includes a ground-fault detector and a simulated ground fault generator. When the ground fault detecting signal is output within an predetermined time and the output of the ground fault detecting signal is stopped as the simulated ground fault generator stops operating, a control section causes the power section to continue outputting electricity. When the signal is not output within the predetermined time or when the output of the signal is not stopped as the generator stops operating, the control section stops the power section. Therefore, the apparatus detects abnormality in the ground fault detector and continues supplying electricity without interruption when the detector is in a normal state.

### BACKGROUND OF THE INVENTION

The present invention relates to a power converter apparatus and a method for controlling the apparatus, and more specifically to a power converter apparatus equipped with ground-fault detector.

A typical household outlet having a ground-fault protection function includes a circuit configuration as shown in FIG. 5. An outlet 31 having a ground-fault protection function incorporates a ground-fault circuit interrupter 36. The ground-fault circuit interrupter 36 includes a sensor 32, which is so called zero phase-sequence current transformer (ZCT), an amplifier 33, which amplifies the detected voltage of the sensor 32, and a trip coil 35 for opening breaker contacts 34. The outlet 31 includes a ground-fault circuit 39, in which resistor 37 and a push button switch 38 are connected in series to intentionally cause a simulated ground-fault. When the push button switch 38 is pressed, the outlet 31 is in a state that is the same as when a ground-fault occurs. If the ground-fault circuit interrupter 36 is normal, the trip coil 35 is actuated to open the breaker contacts 34. After checking that the ground-fault circuit interrupter 36 is normal, the breaker contacts 34 are restored to a closed state.

However, the outlet 31 requires a user to check whether the ground-fault circuit interrupter 36 operates normally by manipulating the push button switch 38. Therefore, if the user fails to inspect the ground-fault circuit interrupter 36, the ground-fault circuit interrupter 36 may be left unfixed even it has faults. Thus, when a ground-fault actually occurs, the ground-fault circuit interrupter 36 may not function effectively.

To solve this problem, an apparatus for automatically checking whether a ground-fault circuit interrupter is normal has been proposed (for example, Japanese Laid-Open Patent Publication No. 6-88368 and No. 9-46886). The above publication No. 6-88368 proposes a ground fault breaker check apparatus for bidet toilet seat. The check apparatus is connected to a commercial AC power source line and includes a ground fault breaker, which consists of a breaker contact and simulated ground fault means. The breaker contact is opened when there is a ground fault to disconnect the AC power source line. The simulated ground fault means generates a simulated ground fault in the commercial AC power source line. The check apparatus includes counting means for accumulating the number of times the toilet seat is used and ground fault test means for sending a test signal to the simulated ground fault means when the accumulated value exceeds a predetermined value. The check apparatus includes a toilet seat controller, which includes a judging section. When the ground fault test means checks the breaker, the judging section decodes monitor signals representing the operation state of the breaker contacts, and judges whether the ground fault breaker is normal or abnormal. The judging section then displays the judgment result.

The above publication No. 9-46886 discloses a ground-fault preventing apparatus, which includes ground-fault circuit interrupting means, a simulated operation section, and interrupting operation detector. The ground-fault circuit interrupting means shuts off electric supply to the device in response to the occurrence of a ground fault in the device. The simulated operation section operates the ground fault interrupting means as simulation upon receipt of an inspection command for inspecting the ground fault interrupting means. The interrupting operation detector detects the operation of the ground fault interrupting means. The ground fault preventing apparatus also includes control means that automatically sends an inspection command to the simulated operation section in accordance with the driving of the device. The control means automatically inspects the state of the ground fault interrupting means based on the detection of the interrupting operation detector.

In the apparatuses disclosed in the above publications No. 6-88368 and No. 9-46886, the ground-fault circuit interrupter is automatically inspected even if the user does not execute the inspection. However, the electric supply to the device is temporarily stopped in both apparatuses even if the ground-fault circuit interrupter is normal. Then, the electric supply to the device is resumed after the opened breaker contact of the ground-fault circuit interrupter is closed. That is, in the conventional apparatuses, the electric supply to the device is unnecessarily interrupted. It is also required to restore the opened breaker contact to a closed state.

In a case where a ground-fault circuit interrupter is attached to an inverter apparatus used for variable speed drive of an electric motor, if the apparatus disclosed in Japanese Laid-Open Patent Publication No. 6-88368 or No. 9-46886 is used to detect whether there is an abnormality in the ground fault detector, the electric motor is stopped immediately after it is started, which is resumed soon after. Therefore, the electric motor is unnecessarily stopped and resumed. The same problem arises when using power converters other than the inverter apparatus, such as a DC/DC converter and an AC/DC converter, with the power source for electric device.

### SUMMARY OF THE INVENTION

Accordingly, it is an objective of the present invention to provide a power converter apparatus that detects abnormality in ground fault detector and continues supplying electricity without interruption when the ground fault detector is in a normal state. The present invention also pertains to a method for controlling the apparatus.

To achieve the above objective, the present invention provides a power converter apparatus. The apparatus converts electricity supplied from a power source into a different form and outputs the electricity to an output line. The apparatus includes a power section having a switching element. The output line is connected to the power section. The power section converts electricity supplied from the power source into the different form and outputs the electricity to the output line by ON/OFF operation of the switching element. A ground-fault detector detects a ground fault in the output line and outputs a ground fault detecting signal. A simulated ground fault generator generates a simulated ground fault state in the output line. A judging section judges whether the ground fault detecting signal is output within a predetermined time of the operation of the simulated ground fault generator, and judges whether the output of the ground fault detecting signal is stopped as the simulated ground fault generator stops operating. A control section controls the power section based on the judgment of the judging section. When the ground fault detecting signal is output within the predetermined time and the output of the ground fault detecting signal is stopped as the simulated ground fault generator stops operating, the control section causes the power section to continue outputting electricity. When the ground fault detecting signal is not output within the predetermined time or when the output of the ground fault detecting signal is not stopped as the simulated ground fault generator stops operating, the control section stops the power section.

According to another aspect of the invention, a method for controlling a power converter apparatus is provided. The apparatus converts electricity supplied from a power source into a different form and outputs the electricity to an output line. The method includes detecting a ground fault in the output line and outputting a ground fault detecting signal. A simulated ground fault state in the output line is generated for a predetermined time. Outputting electricity to the output line is continued when the ground fault detecting signal is output within the predetermined time and the output of the ground fault detecting signal is stopped as the simulated ground fault generator stops operating. Outputting electricity to the output line is stopped when the ground fault detecting signal is not output within the predetermined time or when the output of the ground fault detecting signal is not stopped as the simulated ground fault generator stops operating.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a diagram illustrating one embodiment of the present invention;

FIG. 1(b) is a diagram illustrating a modified embodiment of the present invention;

FIG. 1(c) is a diagram illustrating a modified embodiment of the present invention;

FIG. 2 is a flowchart showing a ground fault detecting operation;

FIG. 3 is a block circuit diagram illustrating the configuration of a judging section according to a modified embodiment of the present invention;

FIG. 4 is a diagram illustrating a modified embodiment of the present invention; and

FIG. 5 is a diagram illustrating a conventional outlet equipped with a ground fault detecting function checking apparatus.

### DETAILED DESCRIPTION OF THE PREFERRED EMBODIMENTS

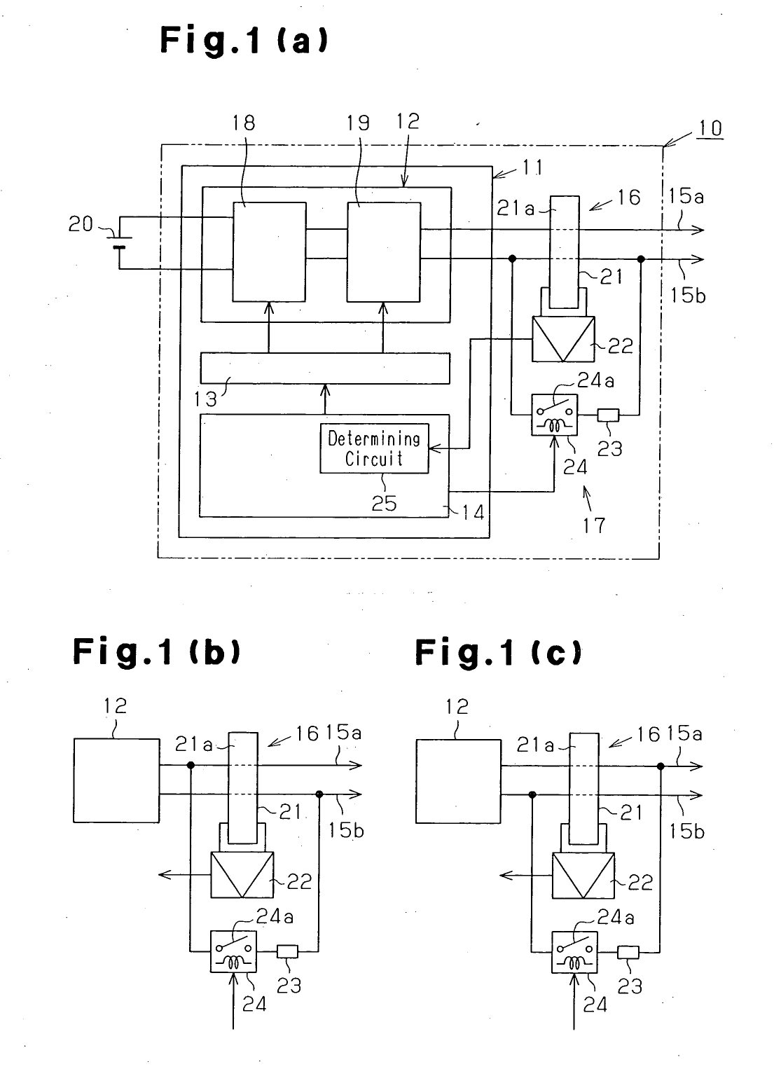

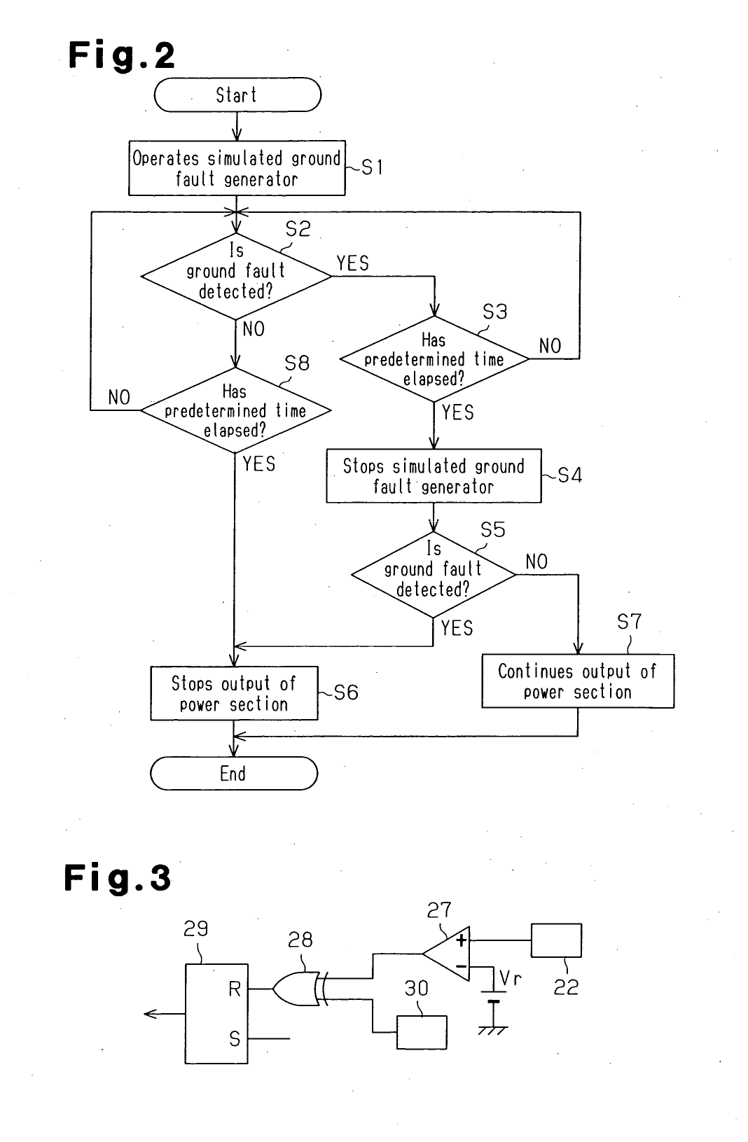

An inverter apparatus 10 for vehicles according to one embodiment of the present invention will now be described with reference to FIGS. 1(a) and 2. The inverter apparatus 10 converts a DC output of a battery 20 to an AC output. FIG. 1(a) is a schematic diagram of a power converter apparatus, which is the inverter apparatus 10 in this embodiment. FIG. 2 is a flowchart explaining operations performed when a ground fault is detected.

As shown in FIG. 1(a), an inverter section 11, which forms part of the inverter apparatus 10, includes a power section 12, a drive circuit 13, and a control section 14 in this embodiment. The output lines 15a and 15b are connected to the power section 12. Current from the power section 12 flows from the output line 15a to the output line 15b or in the reverse direction in a reciprocating manner. The inverter apparatus 10 also includes a ground fault detector 16, which detects a ground fault in the output lines 15a and 15b, and a simulated ground fault generator 17, which generates a simulated ground fault state in the output line 15b.

The power section 12 includes a DC-DC converter 18 and a DC-AC inverter 19. The DC-DC converter 18 includes a pair of switching element, which is not shown, a boosting transformer, and a rectifying circuit. The DC-DC converter 18 boosts a DC voltage supplied from the battery 20 and supplies the boosted DC voltage (for example, DC voltage that is boosted to 100 volts) to the DC-AC inverter 19. The DC-AC inverter 19 includes an H-bridge circuit (not shown), and converts the DC voltage boosted by the DC-DC converter 18 to an AC voltage. That is, the power section 12 converts DC electricity supplied from the power source, which is the battery 20 in this embodiment, to AC electricity, and outputs the AC electricity. The DC-DC converter 18 and the DC-AC inverter 19 have, for example, a known structure.

The DC-DC converter 18 and the DC-AC inverter 19 include several switching elements (such as MOS transistors). The gates of the switching elements are connected to the drive circuit 13. The drive circuit 13 is connected to the control section 14. The drive circuit 13 controls ON/OFF state of each switching element based on control signals from the control section 14 so that the DC voltage is boosted in the DC-DC converter 18 and the DC voltage is converted to the AC voltage in the DC-AC inverter 19.

The ground fault detector 16 includes a zero phase-sequence current transformer (ZCT) 21 and an amplifier 22. Primary conductors, which are the output lines 15a and 15b, extend through a ring core 21a of the ZCT 21. The amplifier 22 amplifies voltage generated in a detection coil, which is not shown, in proportion to a ground fault current, and sends the amplified voltage to the control section 14.

The simulated ground fault generator 17 is formed by a resistor 23 and a relay 24. The resistor 23 is connected to the output line 15b in parallel via a breaker contact 24a of the relay 24 such that the resistor 23 straddles the ground fault detector 16. In other words, one end of the resistor 23 is to a section of the output line 15b between the power section 12 and the ground fault detector 16 via the breaker contact 24a. The other end of the resistor 23 is connected a section of the same output line 15b that is on the opposite side of the ground fault detector 16 with respect to the power section 12. The breaker contact 24a is closed when the relay 24 is excited and is open when the relay 24 is de-excited. When closed, the breaker contact 24a permits electricity to flow.

The control section 14 is a microcomputer, which includes a central processing unit (CPU) and a memory, which are not shown. The microcomputer functions as a controller. The memory stores various control programs required to drive the DC-DC converter 18 and the DC-AC inverter 19. The memory also stores a control program for operating the simulated ground fault generator 17 for a predetermined time and a program for judging whether a ground fault is occurring based on the output from the ground fault detector 16 and judging whether the ground fault detector 16 is present. The predetermined time is set to a time longer than the minimum time required to detect a ground fault. The predetermined time can be changed as required.

The judgment of the occurrence of a ground fault is performed by a determining circuit 25 located in the control section 14 as a program. The determining circuit 25 judges that there is a ground fault when the output voltage of the amplifier 22 is greater than or equal to a predetermined value.

The control section 14 constitutes judging section for judging whether a ground fault detecting signal is output from the ground fault detector 16 within a predetermined time after the simulated ground fault generator 17 has started operation and judging whether the ground fault detector 16 has stopped outputting the ground fault detecting signal based on the output of an operation stop command. The judging section judges that the ground fault detector 16 is normal when the ground fault detector 16 outputs a ground fault detecting signal within the predetermined time and stops outputting the ground fault detecting signal based on the output of the operation stop command. The judging section judges that the ground fault detector 16 is abnormal when the ground fault detector 16 does not output a ground fault detecting signal within the predetermined time or does not stop outputting the ground fault detecting signal based on the output of the operation stop command.

The control section 14 is connected to the relay 24 via an output circuit, which is not shown, based on a control program for operating and stopping the simulated ground fault generator 17. At the activation of the power section 12, the control section 14 outputs an excitation command of the relay 24, that is, an operation command of the simulated ground fault generator 17. Then, after a predetermined time has elapsed from when the operation command is output, the control section 14 outputs a de-excitation command of the relay 24, that is, an operation stop command of the simulated ground fault generator 17.

When it is determined, after the activation of the power section 12, that the ground fault detector 16 is normal based on the judgment of the judging section, the control section 14 continues the output from the power section 12. On the other hand, when it is determined that the ground fault detector 16 is abnormal, the control section 14 controls the power section 12 to stop the output from the power section 12.

The operations of the inverter apparatus 10 formed as described above will now be described.

When an activation switch, which is not shown, is switched on, the ON/OFF state of the switching element in the DC-DC converter 18 are controlled so that a voltage higher than the voltage of the battery 20 is supplied to the DC-AC inverter 19 from the DC-DC converter 18. Also, the ON/OFF state of the switching element in the DC-AC inverter 19 is controlled so that the DC voltage is converted to the AC voltage and sent to the output lines 15a, 15b.

Switching the activation switch on also starts the operation for checking whether there is an abnormality in the ground fault detector 16. The operation will now be described with reference to the flowchart of FIG. 2.

At step S1, the control section 14 sends an operation command to the simulated ground fault generator 17. That is, an excitation command is sent to the relay 24. Then, when the breaker contact 24a is closed, the resistor 23 forms an electric path that bypasses the ZCT 21 on the output lines 15a. That is, the output line 15b is short-circuited in a simulated manner and, which forms a simulated ground fault state. When the simulated ground fault state occurs, a difference is caused between the current values flowing through the output lines 15a, 15b, and a voltage corresponding to the ground fault current is generated in a secondary coil of the ZCT 21. Then, a signal amplified by the amplifier 22 is sent to the determining circuit 25.

At step S2, the control section 14 determines whether the ground fault detecting signal is output, that is, whether a ground fault is detected by the determining circuit 25. When the ground fault is detected, the control section 14 proceeds to step S3. At step S3, the control section 14 judges whether a predetermined time has elapsed. If it is determined that the predetermined time has not elapsed at step S3, the control section 14 returns to step S2. If it is determined that the predetermined time has elapsed, the control section 14 proceeds to step S4 and outputs an operation stop command signal to the simulated ground fault generator 17. That is, the control section 14 sends a de-excitation command signal to the relay 24. When the relay 24 receives the de-excitation command, the breaker contact 24a is opened and the simulated ground fault state is cancelled.

The control section 14 then proceeds to step S5 and determines whether a ground fault is detected by the determining circuit 25. If it is determined that a ground fault is detected at step S5, the control section 14 proceeds to step S6 and stops the output of the power section 12. This is because if a ground fault is detected although the simulated ground fault is stopped, there is a real ground fault. Therefore, the output of the power section 12 is stopped for preventing danger.

On the other hand, when a ground fault is not detected in step S5, the control section 14 proceeds to step S7 and continues the output of the power section 12 and terminates the operation for checking the existence of abnormality in the ground fault detector 16. This is because, the ground fault detector 16 is normal if a ground fault is detected in the state where the simulated ground fault is caused and a ground fault is not detected when the simulated ground fault is stopped.

If a ground fault is not detected in step S2, the control section 14 proceeds to step S8 and judges whether the predetermined time has passed from when the simulated ground fault generator 17 started operation. If the predetermined time has not elapsed, the control section 14 returns to step S2. If the predetermined time has elapsed, the control section 14 proceeds to step S6 and stops the output of the power section 12. This is because if a ground fault is not detected although the predetermined time has elapsed from when the simulated ground fault is caused, the possibility that the ground fault detector 16 has an abnormality is high. Therefore, if the output of the power section 12 is continued in this case, the ground fault detector 16 is highly likely to fail to detect a ground fault when a ground fault actually occurs.

After checking the existence of abnormality in the ground fault detector 16, the output of the AC voltage from the power section 12 is continued if the ground fault detector 16 is determined to be normal. If a real ground fault occurs, that is, if the ground fault detector 16 detects a ground fault when the simulated ground fault generator 17 is not operating, the control section 14 stops sending a drive command to the drive circuit 13 and stops the output of electricity (AC voltage) from the power section 12.

The preferred embodiment provides the following advantages.

(1) The inverter apparatus 10 includes the power section 12, the ground fault detector 16, and the simulated ground fault generator 17. The power section 12 converts the electricity supplied from the battery 20 by ON/OFF operation of the switching element. The ground fault detector 16 detects a ground fault in the output line 15b connected to the power section 12. The simulated ground fault generator 17 generates a simulated ground fault state in the output line 15b. The inverter apparatus 10 includes the judging section and the control section 14. The judging section judges whether the ground fault detector 16 operates normally when the simulated ground fault occurs. If the ground fault detector 16 is normal, the control section 14 continues the output of the power section 12 and if the ground fault detector 16 is abnormal, the control section 14 stops the output of the power section 12. Therefore, the existence of abnormality in the ground fault detector 16 can be checked by detecting the simulated ground fault while not interrupting the electric supply if the ground fault detector 16 is normal. As a result, contrary to the conventional apparatus equipped with a ground-fault circuit interrupter, unnecessary interruption of the electric supply and restoring operation of the ground-fault circuit interrupter are eliminated.

(2) When the breaker contact 24a of the relay 24 is closed, the resistor 23 of the simulated ground fault generator 17 forms an electric path that connects the section of the output line 15b between the power section 12 and the ground fault detector 16 to the section of the same output line 15b that is on the opposite side of the ground fault detector 16 with respect to the power section 12. Therefore, the current through the simulated ground fault generator 17 is also output to a device (load) through the output line 15b. Therefore, the existence of abnormality of the ground fault detector 16 is detected without increasing the load on the inverter section 11 (the power section 12).

(3) The simulated ground fault generator 17 is operated for the predetermined time at least when the power section 12 is activated. Therefore, the ground fault is generated at least when the power section 12 is activated, and the existence of abnormality in the ground fault detector 16 is detected. As a result, even if the user does not perform a special manipulation for detecting a ground fault, the existence of abnormality in the ground fault detector 16 is automatically detected.

(4) The preferred embodiment is applied to the inverter apparatus 10 for vehicles. Since the inverter apparatus 10 for vehicles is not used for a long period, inspecting the ground fault detector 16 at the activation of the power section 12 is sufficient for maintaining the reliability of the ground fault detector 16.

(5) Using the ZCT 21 for the ground fault detector 16 facilitates the detection of a ground fault as compared to other sensors.

(6) The microcomputer constitutes the operating means for operating the simulated ground fault generator 17 for the predetermined time and the judging section for judging the existence of abnormality in the ground fault detector 16. This reduces the number of parts and facilitates the setting of the predetermined time.

(7) The power section 12 outputs AC voltage. Therefore, the power converter apparatus of the preferred embodiment is suitable for the inverter apparatus for vehicles.

The invention may be embodied in the following forms.

As shown in FIG. 1(b), one end of the resistor 23 of the simulated ground fault generator 17 may be connected to a section of the output line 15a between the power section 12 and the ground fault detector 16 via the breaker contact 24a of the relay 24, and the other end of the resistor 23 may be connected a section of the other output line 15b that is on the opposite side of the ground fault detector 16 with respect to the power section 12. In this case, the simulated ground fault generator 17, during its operation, connects the output line 15a with the other line 15b while straddling the ground fault detector 16. Likewise, as shown in FIG. 1(c), one end of the resistor 23 may be connected to a section of the output line 15a that is on the opposite side of the ground fault detector 16 with respect to the power section 12, and the other end of the resistor 23 may be connected a section of the other output line 15b between the power section 12 and the ground fault detector 16 via the breaker contact 24a of the relay 24.

In the embodiments shown in FIGS. 1(b) and 1(c), when the breaker contact 24a of the relay 24 is closed, a closed loop of the electric path including the power section 12 is formed even if the output lines 15a, 15b are not connected to a device (load). Therefore, even if no device (load) is connected to the output lines 15a, 15b, the existence of abnormality in the ground fault detector 16 is detected.

The application of the power converter apparatus is not limited to the inverter apparatus 10 for vehicles but the power converter may be applied to other inverter apparatuses that use the battery 20 as the power source or an inverter apparatus that converts AC voltage to DC voltage by an AC-DC converter and then converts the DC voltage to AC voltage by the DC-AC inverter 19.

The application of the preferred embodiment is not limited to inverter apparatuses for single-phase current but the preferred embodiment may be applied to inverter apparatuses for three-phase current.

The ground fault detector 16 need not use the ZCT 21. For example, the ground fault detector 16 may use a shunt resistor type current sensor or a hall element type current sensor. When the power converter apparatus outputs DC electricity, a hall element type current sensor is preferably used. In the case where the ZCT 21 is used, a ground fault can be detected by single ZCT 21. However, when using the shunt resistor type current sensor or the hall element type current sensor, the current sensor must be provided for each of the output lines to accurately detect a ground fault.

The preferred embodiment need not be applied to the inverter apparatus that outputs AC electricity, which serves as the power converter apparatus, but may be applied to a power converter apparatus that outputs DC electricity such as a DC-DC converter and an AC-DC converter. In this case, the ground fault detector 16 uses the hall element type current sensor instead of the ZCT 21.

The simulated ground fault generator 17 may be operated for a predetermined time at a predetermined cycle. For example, the control section 14 measures the time with an incorporated timer and outputs an operation command for operating the simulated ground fault generator 17 for a predetermined time at a predetermined cycle. In this case, the simulated ground fault is generated at the predetermined cycle and the existence of abnormality in the ground fault detector 16 is detected. The predetermined cycle is set in accordance with the using condition of the power converter apparatus. Therefore, even if the user do not manipulate for detecting a ground fault, the existence of abnormality in the ground fault detector 16 is automatically detected. Since the simulated ground fault is generated at the predetermined cycle, the existence of abnormality in the ground fault detector 16 is periodically and automatically detected even when the power converter apparatus is continuously used for a long time once the power converter apparatus is activated.

The predetermined cycle may be set regardless of the activation of the power section 12 or may be set based on the activation of the power section 12. When the predetermined cycle is set based on the activation of the power section 12, a ground fault is preferably detected at the time of activation. However, a ground fault may be detected at the predetermined cycle after the activation without detecting a ground fault at the time of activation.

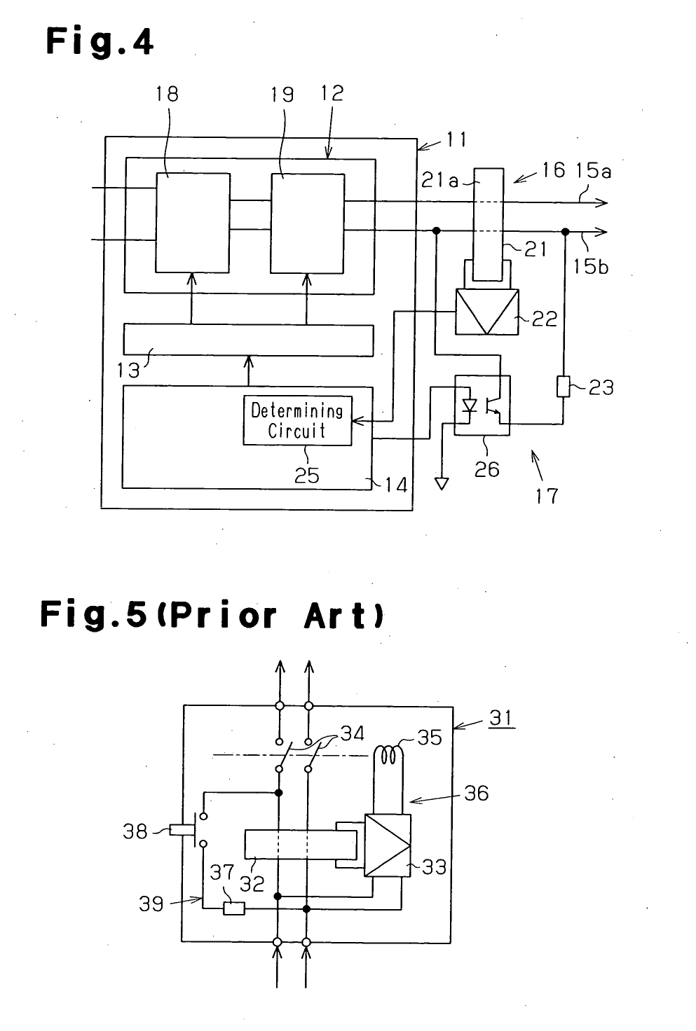

Instead of the relay 24 forming the simulated ground fault generator 17, a photo coupler 26 as shown in FIG. 4 or a noncontact switch such as a semiconductor may be used. In these cases, as compared to a contact switch such as the relay 24, life of the simulated ground fault generator 17 is extended.

The operating means, which operates the simulated ground fault generator 17 for the predetermined time, may be constituted by hardware instead of software. For example, a timer that starts counting at the activation of the power section 12 is provided as the operating means, and a self-holding relay that is switched on based on the activation command of the power section 12 is provided as the relay 24. A normally closed contact of the timer is connected in series to a circuit, to which the resistor 23 and the relay 24 are connected. With this structure, the relay 24 is excited at the activation of the power section 12 so that the simulated ground fault generator 17 starts operation. When the timer counts a predetermined value, the relay 24 is de-excited so that the simulated ground fault generator 17 stops operation.

The judging section for judging the existence of abnormality in the ground fault detector 16 may be constituted with hardware instead of the microcomputer. For example, as shown in FIG. 3, a comparator 27, an exclusive-OR circuit 28, and a latch circuit, which is an RS flip-flop circuit 29, are provided. The comparator 27 compares the output of the amplifier 22 with a reference voltage Vr. When the output of the amplifier 22 is greater than or equal to the reference voltage Vr, the comparator 27 outputs a signal of H level. The output of the comparator 27 and the output of a circuit 30 are entered to the exclusive-OR circuit 28. The circuit 30 outputs a signal of H level when the relay 24 is on (excited) and outputs a signal of L level when the relay 24 is off (de-excited). The set terminal S of the RS flip-flop circuit 29 receives a pulse signal when the power source is turned on and the reset terminal R of the RS flip-flop circuit 29 receives the output from the exclusive-OR circuit 28. When the RS flip-flop circuit 29 is in an unlatched state (set state), the control section 14 can output a control command signal to the drive circuit 13. On the other hand, when the RS flip-flop circuit 29 is in a latched state (reset state), the control section 14 cannot send a control command signal to the drive circuit 13. Therefore, when the power source is turned on, the RS flip-flop circuit 29 is unlatched so that the output of the power section 12 is permitted. After that, when a signal of H level is sent to the reset terminal R from the exclusive-OR circuit 28, the RS flip-flop circuit 29 is reset so that the output of the power section 12 is stopped.

The comparator 27 outputs a signal of H level when a ground fault is detected. The ground fault is detected when the ground fault detector 16 is normal and when there is an actual ground fault or a simulated ground fault. Since the relay 24 is on when a simulated ground fault is generated, a signal of H level is output from the circuit 30. Therefore, if the ground fault detector 16 is normal, the output of the exclusive-OR circuit 28 is L level. Since the relay 24 is off when a simulated ground fault is not generated, a signal of L level is output from the circuit 30. At this time, if the ground fault detector 16 is normal, the comparator 27 outputs a signal of L level, and the output of the exclusive-OR circuit 28 is maintained to L level. Therefore, if the ground fault detector 16 is normal, even if the outputs of the comparator 27 and the circuit 30 are changed, the exclusive-OR circuit 28 outputs a signal of L level and the output of the RS flip-flop circuit 29 is maintained at H level. Thus, the output from the power section 12 is continued. If there is an abnormality in the ground fault detector 16, the comparator 27 outputs a signal of H level while a signal of L level is output from the circuit 30 or the comparator 27 outputs a signal of L level while a signal of H level is output from the circuit 30. As a result, a signal of H level is sent to the reset terminal R of the RS flip-flop circuit 29 from the exclusive-OR circuit 28. Then, the output of the RS flip-flop circuit 29 becomes L level and the output of the power section 12 is stopped.

The operation of the simulated ground fault generator 17 need not be performed automatically. For example, in addition to the automatic operation, the simulated ground fault generator 17 may be designed to be operated manually. Alternatively, the simulated ground fault generator 17 may be designed to be only operated manually. In the structure in which the simulated ground fault generator 17 is operated both manually and automatically, for example, a manual switch is connected to the breaker contact 24a of the relay 24 in parallel. In the structure in which the simulated ground fault generator 17 is operated only manually, for example, a manual switch is connected to the resistor 23 in series instead of the relay 24.

The AC voltage output from the inverter apparatus 10 for vehicles need not be 100V but may be other level of AC voltage (e.g. 110V, 200V) used by home electric appliances.

The present examples and embodiments are to be considered as illustrative and not restrictive and the invention is not to be limited to the details given herein, but may be modified within the scope and equivalence of the appended claims.

1. A power converter apparatus that converts electricity supplied from a power source into a different form and outputs the electricity to an output line, the apparatus comprising:
a power section having a switching element, wherein the output line is connected to the power section, and wherein the power section converts electricity supplied from the power source into the different form and outputs the electricity to the output line by ON/OFF operation of the switching element;
a ground-fault detector that detects a ground fault in the output line and outputs a ground fault detecting signal;
a simulated ground fault generator that generates a simulated ground fault state in the output line;
a judging section that judges whether the ground fault detecting signal is output within a predetermined time of the operation of the simulated ground fault generator, and judges whether the output of the ground fault detecting signal is stopped as the simulated ground fault generator stops operating; and
a control section that controls the power section based on the judgment of the judging section, wherein, when the ground fault detecting signal is output within the predetermined time and the output of the ground fault detecting signal is stopped as the simulated ground fault generator stops operating, the control section causes the power section to continue outputting electricity, and wherein, when the ground fault detecting signal is not output within the predetermined time or when the output of the ground fault detecting signal is not stopped as the simulated ground fault generator stops operating, the control section stops the power section.

2. The apparatus according to claim 1, wherein the ground fault detector is located on the output line, the simulated ground fault generator, during its operation, forms an electric path that connects a section of the output line between the power section and the ground fault detector to a section of the output line that is on the opposite side of the ground fault detector with respect to the power section.

3. The apparatus according to claim 1, wherein the output line is one of a pair of output lines, the ground fault detector is located on the output lines, the simulated ground fault generator, during its operation, forms an electric path that connects a section of one of the output lines between the power section and the ground fault detector to a section of one of the output lines that is on the opposite side of the ground fault detector with respect to the power section.

4. The apparatus according to claim 3, wherein the electric path formed during the operation of the simulated ground fault generator connects a section of one of the output lines between the power section and the ground fault detector to a section of the same output line that is on the opposite side of the ground fault detector with respect to the power section.

5. The apparatus according to claim 3, wherein the electric path formed during the operation of the simulated ground fault generator connects a section of one of the output lines between the power section and the ground fault detector to a section of the other output line that is on the opposite side of the ground fault detector with respect to the power section.

6. The apparatus according to claim 3, wherein the simulated ground fault generator includes a switch that opens or closes the electric path, and the simulated ground fault generator, during its operation, closes the switch to permit electricity to flow.

7. The apparatus according to claim 1, wherein the simulated ground fault generator, during its operation, forms an electric path on the output line, which electric path straddles the ground fault detector.

8. The apparatus according to claim 1, wherein the output line is one of a pair of output lines, wherein the simulated ground fault generator, during its operation, connects one of the output lines to the other output line while straddling the ground fault detector, thereby forming a closed loop circuit that includes the power section.

9. The apparatus according to claim 1, wherein the ground fault detector has a zero phase-sequence current transformer and an amplifier circuit.

10. The apparatus according to claim 1, wherein the simulated ground fault generator operates at least for a predetermined time at the activation of the power section.

11. The apparatus according to claim 1, wherein the simulated ground fault generator operates for a predetermined time at a predetermined cycle.

12. The apparatus according to claim 1, wherein the power section converts a direct current to an alternating current or converts an alternating current to a direct current.

13. The apparatus according to claim 1, further comprises a computer that functions as the control section and the judging section.

14. The apparatus according to claim 1, wherein the judging section is formed by a comparator, an exclusive OR circuit, and a latch circuit.

15. A power converter apparatus that converts supplied electricity into a different form and outputs the electricity to a pair of output lines, the apparatus comprising:
a power section that includes at least one of converters and inverters of DC-DC type, DC-AC type, AC-DC type and AC-AC type;
a ground-fault detector that detects a ground fault in the output lines, and outputs a ground fault detecting signal, wherein the ground fault detector is located on the output lines;
an electric path, wherein, at least for a predetermined time at the activation of the power section, the electric path connects a section of one of the output lines between the power section and the ground fault detector to a section of one of the output lines that is on the opposite side of the ground fault detector with respect to the power section; and
a controller that controls the power section, wherein, when the ground fault detecting signal is output within the predetermined time and the output of the ground fault detecting signal is stopped as the electric path is open, the controller causes the power section to continue outputting electricity, and wherein, when the ground fault detecting signal is not output within the predetermined time or when the output of the ground fault detecting signal is not stopped as the electric path is open, the controller stops the output of electricity from the power section.

16. A method for controlling a power converter apparatus that converts electricity supplied from a power source into a different form and outputs the electricity to an output line, the method comprising:
detecting a ground fault in the output line and outputting a ground fault detecting signal;
generating a simulated ground fault state in the output line for a predetermined time;
continuing outputting electricity to the output line when the ground fault detecting signal is output within the predetermined time and the output of the ground fault detecting signal is stopped as the simulated ground fault generator stops operating; and
stopping outputting electricity to the output line when the ground fault detecting signal is not output within the predetermined time or when the output of the ground fault detecting signal is not stopped as the simulated ground fault generator stops operating.

17. The method according to claim 16, wherein the output line is one of a pair of output lines, the ground fault in each output line is detected at a detection section of the output line, and the simulated ground fault state is generated in one of the output lines by flowing electricity such that the electricity straddles the section.

18. The method according to claim 16, wherein the output line is one of a pair of output lines, the ground fault in each output line is detected at a detection section of the output line, and the simulated ground fault state is generated by flowing electricity from a section of one of the output lines that is closer to the power source than to the detection section to a section of the other output line that is on the opposite side of the detection section with respect to the power source or by flowing electricity in the reverse direction.

19. The method according to claim 16, wherein the simulated ground fault state is generated at least for a predetermined time at the activation of the apparatus.

20. The method according to claim 16, wherein the simulated ground fault state is generated for a predetermined time at a predetermined cycle.
